(19) United States
(12) Patent Application Publication
(10) Pub. No.: US 2024/0196959 A1
(43) Pub. Date: Jun. 20, 2024

(54) SMOKING ARTICLE AND AEROSOL GENERATING SYSTEM INCLUDING THE SAME

(71) Applicant: KT&G CORPORATION, Daejeon (KR)

(72) Inventors: Jung Kyu SEO, Daejeon (KR); Hyung Jin BAE, Daejeon (KR); Da Bin SONG, Daejeon (KR); Young Rim HAN, Daejeon (KR)

(73) Assignee: KT&G CORPORATION, Daejeon (KR)

(21) Appl. No.: 18/287,414

(22) PCT Filed: Jan. 16, 2023
(86) PCT No.: PCT/KR2023/000706

§ 371 Date: Oct. 18, 2023

(30) Foreign Application Priority Data
Jan. 24, 2022 (KR) 10-2022-0009976

(51) Int. Cl. A24D 1/20; A24D 1/02; A24D 1/04; A24F 40/20; B32B 15/12; B32B 15/20; B32B 29/00

(52) U.S. Cl. CPC A24D 1/20; A24D 1/02; A24D 1/045; A24F 40/20; B32B 15/12; B32B 15/20; B32B 29/005; B32B 2307/718; B32B 2307/7376

(57) ABSTRACT

A smoking article includes a medium accommodation portion filled with a plurality of tobacco sheets, a moisturizer accommodation portion disposed on one side of the medium accommodation portion and including an aerosol generating material, and a filter portion disposed on another side of the medium accommodation portion. A wrapper to wrap the medium accommodation portion may be three-ply paper containing aluminum.

### TECHNICAL FIELD

The present disclosure relates to a smoking article, and an aerosol generating system including the smoking article.

### BACKGROUND ART

Recently, demands for alternative ways to overcome disadvantages of general cigarettes have increased. For example, the demand for a method of generating an aerosol by heating an aerosol generating material included in a cigarette rather than by burning the cigarette is increasing.

### DISCLOSURE OF THE INVENTION

### Technical Goals

A technical goal to be achieved by the present disclosure is to provide a smoking article including three-ply paper containing aluminum as a segment wrapper to wrap a medium accommodation portion.

In addition, the present disclosure provides an aerosol generating device that may provide an aerosol that may be inhaled by a user, by heating an aerosol generating material stored in the smoking article.

In addition, the present disclosure provides an aerosol generating system including the smoking article and the aerosol generating device.

However, goals to be achieved are not limited to those described above, and other goals not mentioned above are clearly understood by one of ordinary skill in the art from the following description.

### Technical Solutions

To solve the above problems, the present disclosure provides a smoking article including three-ply paper containing aluminum as a medium accommodation portion wrapper.

In particular, when three-ply paper containing aluminum having a thickness of 15 micrometers (μm) to 25 μm as a segment wrapper wraps a medium accommodation portion of the smoking article, it is found that an amount of atomization of a smoking article including the medium accommodation portion increases.

In an embodiment of the present disclosure, the smoking article may include a medium accommodation portion, a moisturizer accommodation portion disposed on one side of the medium accommodation portion and including an aerosol generating material, and a filter portion disposed on another side of the medium accommodation portion.

In another embodiment of the present disclosure, the three-ply paper may include outer wrapping paper, intermediate wrapping paper, and inner wrapping paper, and the intermediate wrapping paper may include aluminum. The intermediate wrapping paper may include aluminum that desirably has a thickness of 15 micrometers (μm) to 25 μm and more desirably has a thickness of 20 μm.

In another embodiment of the present disclosure, the intermediate wrapping paper may have a basis weight of 50 grams per square meter (gsm) to 60 gsm, and desirably 54.2 gsm.

In another embodiment of the present disclosure, the outer wrapping paper and the inner wrapping paper may each have a thickness of 30 μm to 40 μm, and desirably 35 μm.

In another embodiment of the present disclosure, the outer wrapping paper and the inner wrapping paper may each have a basis weight of 10 gsm to 20 gsm, and desirably 16 gsm.

In another embodiment of the present disclosure, the medium accommodation portion may be filled with a plurality of tobacco sheets, and each of the tobacco sheets may be formed by folding a flat sheet coated with a tobacco medium multiple times.

In another embodiment of the present disclosure, the aerosol generating material may include at least one of glycerin, propylene glycol, and nicotine.

In another embodiment of the present disclosure, the filter portion may include a first filter portion including a cavity therein, and a second filter portion filled with a filtration material.

In another embodiment of the present disclosure, at least one of the medium accommodation portion, the moisturizer accommodation portion, and the filter portion may be wrapped with a segment wrapper. The segment wrapper may include at least one of a medium accommodation portion wrapper, a moisturizer accommodation portion wrapper, a first filter portion wrapper, and a second filter portion wrapper.

In other words, the moisturizer accommodation portion may be wrapped with the moisturizer accommodation portion wrapper. The first filter portion may be wrapped with the first filter portion wrapper, and the second filter portion may be wrapped with the second filter portion wrapper.

In another embodiment of the present disclosure, a plurality of segments wrapped with the segment wrapper may be wrapped with a total wrapper.

The present disclosure also provides an aerosol generating device that is configured to provide an aerosol inhalable by a user, by heating an aerosol generating material stored in the smoking article.

In an embodiment of the present disclosure, the smoking article may be detachably installed (e.g., inserted) in the aerosol generating device.

In another embodiment of the present disclosure, the aerosol generating device may include an elongated cavity configured to accommodate the smoking article, a heater configured to heat at least a part or all of the medium accommodation portion and the moisturizer accommodation portion of the smoking article, and a controller electrically connected to the heater.

In addition, the present disclosure provides an aerosol generating system including the smoking article and the aerosol generating device.

In an embodiment of the present disclosure, the aerosol generating device may include a heater configured to heat of the medium accommodation portion and the moisturizer accommodation portion of the smoking article.

In another embodiment of the present disclosure, a temperature of an unheated part of the smoking article may range from 160° C. to 200° C. Desirably, the temperature may be 179.2° C. when a user inhales an aerosol three to five times, and may be 180.4° C. when the user inhales the aerosol six times or more.

### Effects

According to embodiments, a medium accommodation portion wrapper formed of three-ply paper containing aluminum may effectively transfer heat, and thus an unheated part of a medium accommodation portion may be reduced in comparison to an existing smoking article. As a result, an amount of atomization may be increased.

According to embodiments, a smoking article, an aerosol generating device, and an aerosol generating system may significantly increase an amount of migration of glycerin or menthol.

According to embodiments, a smoking article, an aerosol generating device, and an aerosol generating system may enhance the overall tobacco taste by increasing an intensity and persistence of menthol.

The effects of the smoking article, the aerosol generating device and the aerosol generating system according to an embodiment are not limited to the above-mentioned effects, and other unmentioned effects may be clearly understood from the following description by one of ordinary skill in the art.

### BRIEF DESCRIPTION OF DRAWINGS

FIG. 1 illustrates a diagram of a smoking article according to an embodiment.

FIG. 2 is a diagram illustrating a medium accommodation portion wrapper and a smoking article including the medium accommodation portion wrapper according to an embodiment.

FIG. 3 is a diagram schematically illustrating an aerosol generating device according to an embodiment.

FIG. 4 is a diagram schematically illustrating an aerosol generating system in a state in which a smoking article and an aerosol generating device are coupled, according to an embodiment.

FIGS. 5a and 5b illustrate results obtained by measuring a temperature of each of a heated part and an unheated part of a medium accommodation portion of a smoking article in an aerosol generating system according to an embodiment.

### BEST MODE FOR CARRYING OUT THE INVENTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

A component, which has the same common function as a component included in any one embodiment, will be described by using the same name in other embodiments. Unless disclosed to the contrary, the configuration disclosed in any one embodiment may be applied to other embodiments, and the specific description of the repeated configuration will be omitted.

In the present disclosure, the terms “upstream” and “downstream” are used to indicate relative positions of segments of a smoking article based on a direction in which a user inhales air using the smoking article. The smoking article may include a downstream end (that is, a portion into which air flows) and an upstream end (that is, a portion from which air flows out) opposite to the downstream end. When using the smoking article, a user may bite the downstream end of the smoking article. The downstream end may also be referred to as a mouth end (ME) and the upstream end may also be referred to as a tobacco end (TE). The term “end” may also be described as an “end portion”.

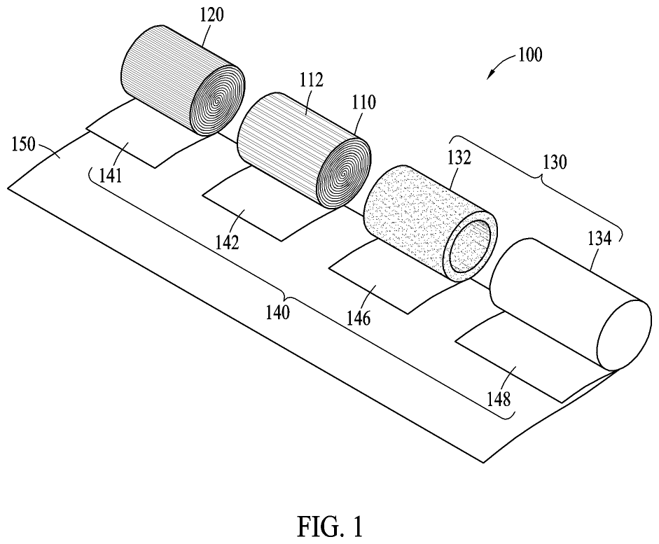

FIG. 1 illustrates a diagram of a smoking article according to an embodiment.

Referring to FIG. 1, a smoking article 100 according to an embodiment may include a medium accommodation portion 110 for generating an aerosol, a moisturizer accommodation portion 120 disposed on one side of the medium accommodation portion 110, and a filter portion 130 disposed on the other side of the medium accommodation portion 110. The smoking article 100 may include a plurality of segments, such as the medium accommodation portion 110, the moisturizer accommodation portion 120, and the filter portion 130. The segments of the smoking article 100 may be individually wrapped with a segment wrapper 140. Alternatively, one or more segments may not be wrapped with a segment wrapper 140. Segments wrapped with the segment wrapper 140 may be wrapped again with a total wrapper 150 to form a single smoking article.

In the present disclosure, the medium accommodation portion 110 may be filled with an aerosol generating material, such as a plurality of tobacco sheets 112, cut tobacco leaves, or tobacco granules. Each of the tobacco sheets may be formed by folding a flat sheet coated with a tobacco medium multiple times. Here, the tobacco medium may be liquid and may include, for example, glycerin, menthol, nicotine, or a combination thereof, and the flat sheet may include, for example, crimped paper, plain raw base paper, and the like, but is not limited thereto. The cut tobacco leaves may refer to a solid material based on tobacco raw materials. The medium accommodation portion 110 may be prepared by finely cutting general cut leaves or a reconstituted tobacco slurry sheet, and may be formed by combining a plurality of cut tobacco leaves randomly or in the same direction. In addition, the medium accommodation portion 110 may be in a form in which a plurality of tobacco granules is included in a flat sheet coated with a tobacco medium. The tobacco medium may include, for example, glycerin, menthol, nicotine, or a combination thereof, and the flat sheet may include, for example, crimped paper, plain raw base paper, and the like, but is not limited thereto.

The medium accommodation portion 110 may further contain other additives such as a moisturizer, a flavoring agent, and/or an organic acid. The moisturizer may be, for example, glycerin, propylene glycol, ethylene glycol, dipropylene glycol, diethylene glycol, triethylene glycol, tetraethylene glycol, or oleyl alcohol, but is not limited thereto. The flavoring agent may be, for example, licorice, sucrose, fructose syrup, isosweet, cocoa, lavender, cinnamon, cardamom, celery, fenugreek, cascarilla, sandalwood, bergamot, geranium, honey essence, rose oil, vanilla, lemon oil, orange oil, mint oil, cinnamon, caraway, cognac, jasmine, chamomile, menthol, cassia, ylang-ylang, sage, spearmint, ginger, coriander, or coffee, but is not limited thereto.

In the present disclosure, the moisturizer accommodation portion 120 may contain a moisturizer. The moisturizer may include glycerin and propylene glycol, and may further include at least one of ethylene glycol, dipropylene glycol, diethylene glycol, triethylene glycol, tetraethylene glycol, oleyl alcohol, and water. In addition, the moisturizer accommodation portion 120 may further include nicotine. However, materials included in the moisturizer accommodation portion 120 are not limited thereto. The moisturizer may maintain an appropriate level of moisture in an aerosol generated when a smoking article is heated, thereby mellowing a unique taste of tobacco and enriching an amount of atomization.

In the present disclosure, the filter portion 130 may include at least one segment, and may include, for example, at least one of a tube filter, a cooling structure, and a recess filter. Desirably, the filter portion 130 may include a first filter portion 132 including a cavity therein, and a second filter portion 134 fully filled with a filtration material. The filtration material may include a cellulose-based material (e.g., acetate, paper, etc.).

In the present disclosure, the segment wrapper 140 may include at least one of a medium accommodation portion wrapper 142, a moisturizer accommodation portion wrapper 141, a first filter portion wrapper 146, and a second filter portion wrapper 148. The segment wrapper 140 may include water-proof paper with water resistance, oil-proof paper with oil resistance, water- and oil-proof paper with water and oil resistance, or paper coated with a material with water resistance and/or oil resistance. The segment wrapper 140 may include aluminum having waterproofing and heat-resistant properties. When the segment wrapper 140 is formed of two-ply paper, the aluminum may be positioned between outer wrapping paper and a segment. When the segment wrapper 140 is formed of three-ply paper, the aluminum may be positioned between the outer wrapping paper and inner wrapping paper. Here, the outer wrapping paper and the inner wrapping paper may be 100% of wood pulp. Based on induction heating characteristics, it may be desirable to apply the three-ply paper containing aluminum to the medium accommodation portion wrapper 142.

To measure physical properties of a smoking article according to an embodiment, analyze aerosol components, evaluate sensory properties, and measure a temperature of a medium accommodation portion, the medium accommodation portion wrapper 142 was prepared as shown in Table 1 below, and a smoking article including the medium accommodation portion wrapper 142 was prepared as shown in Table 2.

TABLE 1

| Aluminum | | | | Total | |
|---|---|---|---|---|---|
| foil | Outer | | Inner | basis | Total |
| wrapping | paper | Aluminum | paper | weight | thickness |
| paper | (g/m²) | (μm) | (g/m²) | (g/m²) | (μm) |
| Two-ply paper | 35 | 6.3 | — | 53.0 | 50.3 |
| (6.3 μm) | | | | | |
| Three-ply paper | 16 | 20 | 16 | 86.2 | 90 |
| (20 μm) | | | | | |

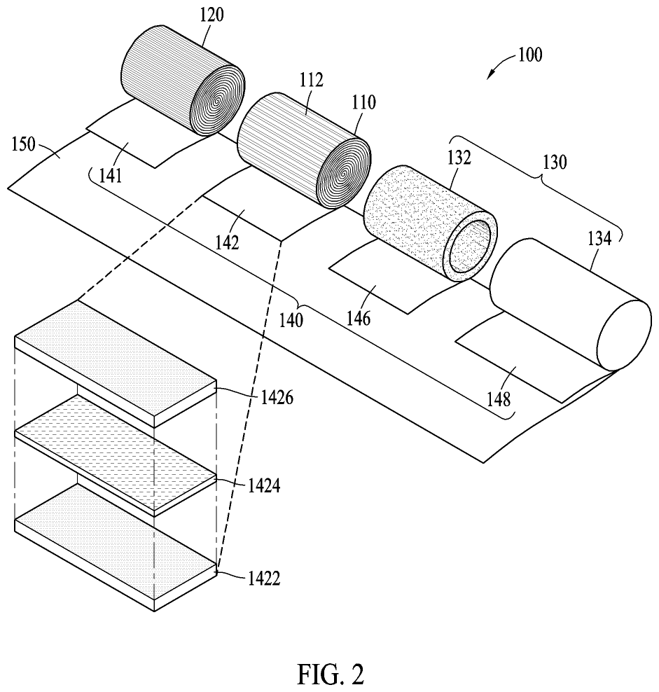

The medium accommodation portion wrapper 142 may be formed of three-ply paper that includes outer wrapping paper 1422, intermediate wrapping paper 1424, and inner wrapping paper 1426. The outer wrapping paper 1422 and the inner wrapping paper 1426 may have a thickness of 35 μm and a basis weight of 16 grams per square meter (gsm), and the intermediate wrapping paper 1424 may have a basis weight of 54.2 gsm and include aluminum with a thickness of 20 μm (FIG. 2).

For comparison, two-ply paper was prepared as a control group and used as a medium accommodation portion wrapper. The two-ply paper includes two layers of wrapping paper, of which outer wrapping paper has a thickness of 44 μm and a basis weight of 35 gsm and intermediate wrapping paper has a basis weight of 18 gsm and includes aluminum with a thickness of 6.3 μm.

TABLE 2

| | Moisturizer | Medium | |
|---|---|---|---|
| | accommodation | accommodation | |
| Classification | portion | portion | Filter portion |
| Control group | 50 mg of solution | Aluminum foil | Same in case of |
| (6.3 μm) | with glycerin | with thickness | first filter |
| | 99.05% and | of 6.3 μm | portion and |
| Experimental | nicotine stock | Aluminum foil | second filter |
| group | solution 0.95% | with thickness | portion |
| (20 μm) | | of 20 μm | |

### Experimental Example 1. Measurement of Physical Properties

First, Table 4 shows results obtained by measuring physical properties of the medium accommodation portion 110 wrapped with the medium accommodation portion wrapper 142 formed of three-ply paper containing aluminum with a thickness of 20 μm, and Table 3 shows results obtained by measuring physical properties of a smoking article including the medium accommodation portion 110.

TABLE 3

| | Weight (mg) | | EPD (mmH₂O) | | Circumference (mm) | | Roundness (mm) | | Length (mm) | |
|---|---|---|---|---|---|---|---|---|---|---|
| Classification | Average | SD | Average | SD | Average | SD | Average | SD | Average | SD |
| Control group | 874 | 8.9 | 90.4 | 15.1 | 22.03 | 0.09 | 93.0 | 2.24 | 72.5 | 0.11 |
| (6.3 μm) | | | | | | | | | | |
| Experimental | 914 | 5.4 | 92.6 | 16.4 | 22.00 | 0.07 | 94.2 | 1.39 | 72.5 | 0.10 |
| group (20 μm) | | | | | | | | | | |

TABLE 4

| | Weight (mg) | | Circumference (mm) | | Vent (%) | | UPD (mmH₂O) | | EPD (mmH₂O) | |
|---|---|---|---|---|---|---|---|---|---|---|
| Classification | Average | SD | Average | SD | Average | SD | Average | SD | Average | SD |
| Control group | 640 | 5.6 | 22.67 | 0.13 | 65.89 | 3.70 | 60.5 | 5.6 | 124 | 14.2 |
| (6.3 μm) | | | | | | | | | | |
| Experimental | 652 | 7.2 | 22.56 | 0.08 | 67.06 | 4.15 | 61.0 | 4.2 | 128 | 15.1 |
| group (20 μm) | | | | | | | | | | |

As the results of measurement of the physical properties, the control group and the experimental group show similar levels of physical properties such as weight, circumference, and resistance to draw, and the like.

### Experimental Example 2. Analysis of Aerosol Components

Table 5 shows results obtained by analyzing components of an aerosol generated by 9 puffs and pack diffusion conditions using a Health Canada (HC) method that is an internationally recognized analysis method for general cigarettes.

TABLE 5

| | HC conditions, 9 puffs, pack diffusion, PV1-2 | | | | | | |
|---|---|---|---|---|---|---|---|
| Classification | TPM | Tar | Nic. | PG | Gly. | Water | Menthol |
| Control group | 30.2 | 17.1 | 0.18 | <LOQ | 9.26 | 12.9 | 1.15 |
| (6.3 μm) | | | | | | | |
| Experimental | 33.4 | 20.3 | 0.19 | <LOQ | 13.25 | 12.9 | 1.53 |
| group (20 μm) | | | | | | | |

As a result, it is confirmed that an aerosol of the experimental group contains a significantly large amount of total particulate matter (TPM), total aerosol residue (Tar), nicotine, propylene glycol, glycerin (Gly), water, and menthol, in comparison to the control group. In particular, an amount of migration of glycerin is increased by 4300 and an amount of migration of menthol is increased by 33%. This indicates that a smoking article according to an embodiment of the present disclosure has a greater amount of atomization and is excellent in taste and flavor.

In addition, to identify a migration amount during an initial inhalation, results obtained by analyzing the components of the aerosol generated by 3 puffs and pack diffusion conditions using the HC method described above are shown in Table 6 below.

TABLE 6

| | HC conditions, initial 3 puffs, pack diffusion, PV1-2 | | | | | | |
|---|---|---|---|---|---|---|---|
| Classification | TPM | Tar | Nic. | PG | Gly. | Water | Menthol |
| Control group | 16.2 | 8.2 | 0.09 | <LOQ | 2.54 | 7.9 | 0.57 |
| (6.3 μm) | | | | | | | |
| Experimental | 17.8 | 9.0 | 0.09 | <LOQ | 3.29 | 8.7 | 0.66 |
| group (20 μm) | | | | | | | |

Even in the initial inhalation, all amounts of migration of the TPM, tar, glycerin (Gly), water, and menthol were high. In particular, the amount of migration of glycerin is increased by 29.5% and the mount of migration of menthol is increased by 15.8%.

### Experimental Example 3. Sensory Evaluation

Heat generated in the smoking article, an initial amount of atomization, a total amount of atomization, an intensity of menthol, stimulus properties, persistence of menthol, and overall tobacco taste were evaluated. Sensory evaluation was measured by a 7-point scoring method after inhaling about 10 to 14 puffs for experts with experience in sensory evaluation in the field of smoking articles, and results of the sensory evaluation are shown in Table 7 below.

TABLE 7

| | | Initial | | | | | |
|---|---|---|---|---|---|---|---|
| | | amount of | | | | | Overall |
| | Stick | atomization | Amount of | Intensity of | Stimulus | Persistence | tobacco |
| Classification | heat | (1 to 2 puffs) | atomization | menthol | properties | of menthol | taste |
| Control group | 3.2 | 3.9 | 5.1 | 3.9 | 2.6 | 4.0 | 4.6 |
| (6.3 μm) | | | | | | | |
| Experimental | 3.2 | 4.9 | 5.8 | 4.5 | 2.6 | 4.4 | 4.9 |
| group (20 μm) | | | | | | | |
| p-value | 0.963 | 0.0001 | 0.0001 | 0.008 | 0.802 | 0.083 | 0.056 |

As a result, it is confirmed that the initial amount of atomization, the total amount of atomization, the intensity of menthol, the persistence of menthol, and the overall tobacco taste of the smoking article were all enhanced, and that, in particular, the control group and the experimental group are statistically significantly different from each other in the initial amount of atomization, the total amount of atomization, the intensity of menthol, the persistence of menthol, and the overall tobacco taste.

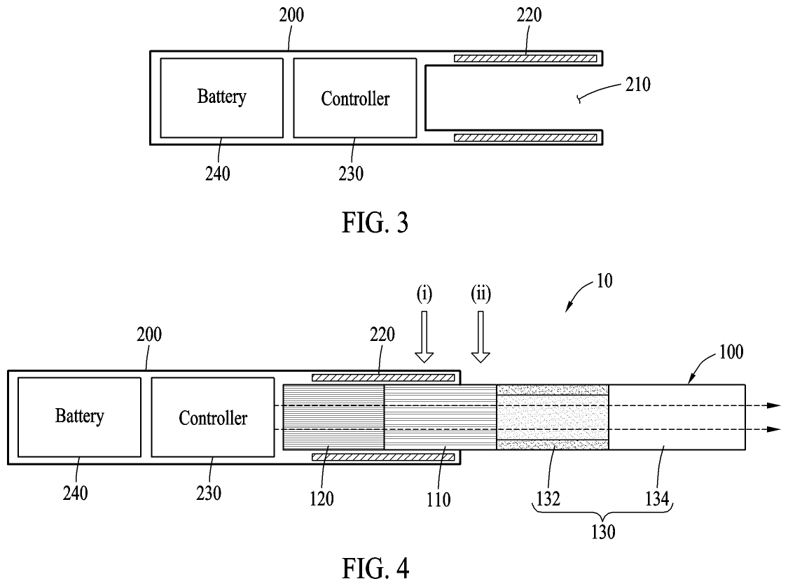

FIGS. 3 and 4 illustrate examples in which a smoking article 100 including a medium accommodation portion wrapper 142 formed of three-ply paper containing aluminum is used.

FIG. 3 is a diagram schematically illustrating an aerosol generating device 200 according to an embodiment.

Referring to FIG. 3, the aerosol generating device 200 may include an elongated cavity 210, a heater 220, and a controller 230. The elongated cavity 210 may be configured to accommodate the smoking article 100. The controller 230 may be electrically connected to the heater 220 to control a temperature to heat the smoking article 100. The aerosol generating device 200 may further include a battery 240 configured to supply power in a process of generating an aerosol.

FIG. 4 is a diagram schematically illustrating an aerosol generating system 10 in a state in which the smoking article 100 and the aerosol generating device 200 are coupled, according to an embodiment.

Referring to FIG. 4, the aerosol generating system 10 may include the smoking article 100, and the aerosol generating device 200. The smoking article 100 may tightly fit an elongated cavity 210 of the aerosol generating device 200. In the state in which the smoking article 100 is coupled to the aerosol generating device 200, the heater 220 may heat a part or all of a medium accommodation portion 110 and a moisturizer accommodation portion 120 of the smoking article 100. Preferably, the heater 220 may heat a downstream end of the moisturizer accommodation portion 120 and an upstream end of the medium accommodation portion 110.

For example, in the smoking article 100, a length of the moisturizer accommodation portion 120 may be 10 mm, a length of the medium accommodation portion 110 may be 12 mm, a length of a first filter portion 132 may be 12 mm, and a second filter portion 134 may be 14 mm. In this example, the heater 220 may heat 7 mm of the downstream end of the moisturizer accommodation portion 120 and 7 mm of the upstream end of the medium accommodation portion 110.

### Experimental Example 4. Measurement of Temperature of Medium Accommodation Portion

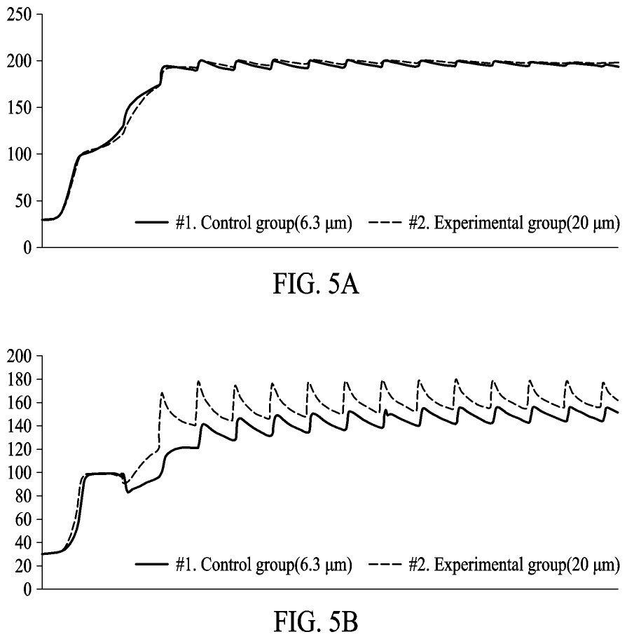

Temperatures of a heated part and an unheated part of the medium accommodation portion 110 of the smoking article 100 were measured. A temperature of a medium accommodation portion located 33 mm upstream from a mouth end (ME) as indicated by (i) of FIG. 4 was measured as a temperature of a heated part, and a temperature of a medium accommodation portion located 28 mm downstream from the ME as indicated by (ii) of FIG. 4 was measured as a temperature of an unheated part, as shown in Table 8 and FIGS. 5a and 5b.

TABLE 8

| | |
|---|---|
| | Temperature of |
| Temperature of | unheated part |
| heated part (measured | (measured at 28 |
| at 33 mm from ME) | mm from ME) |

| | 3 to 5 | After 6 | 3 to 5 | After 6 |
|---|---|---|---|---|
| Classification | puffs | puffs | puffs | puffs |
| Control group | 200.2 | 199.8 | 149.3 | 156.5 |
| (6.3 μm) | | | | |
| Experimental | 201.2 | 201.2 | 179.2 | 180.4 |
| group (20 μm) | | | | |

The medium accommodation portion according to an embodiment of the present disclosure may maintain the temperature of the heated part at about 200° C. and may also increase the temperature of the unheated part by maximizing a heat transfer efficiency. As a result, the amount of atomization of the smoking article may be increased.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A smoking article comprising:
a medium accommodation portion;
a moisturizer accommodation portion disposed on one side of the medium accommodation portion and comprising an aerosol generating material; and
a filter portion disposed on another side of the medium accommodation portion,
wherein the medium accommodation portion is wrapped with a medium accommodation portion wrapper comprising three-ply paper containing aluminum (Al).

2. The smoking article of claim 1, wherein
the three-ply paper comprises outer wrapping paper, intermediate wrapping paper, and inner wrapping paper, and
the intermediate wrapping paper comprises aluminum.

3. The smoking article of claim 2, wherein the intermediate wrapping paper comprises aluminum with a thickness of 15 micrometers (μm) to 25 μm.

4. The smoking article of claim 2, wherein the intermediate wrapping paper has a basis weight of 50 grams per square meter (gsm) to 60 gsm.

5. The smoking article of claim 2, wherein the outer wrapping paper and the inner wrapping paper each have a thickness of 30 μm to 40 μm.

6. The smoking article of claim 2, wherein the outer wrapping paper and the inner wrapping paper each have a basis weight of 10 gsm to 20 gsm.

7. The smoking article of claim 1, wherein
the medium accommodation portion is filled with a plurality of tobacco sheets, and
each of the tobacco sheets is formed by folding a flat sheet coated with a tobacco medium multiple times.

8. The smoking article of claim 1, wherein the aerosol generating material comprises at least one of glycerin, propylene glycol, and nicotine.

9. The smoking article of claim 1, wherein the filter portion comprises:
a first filter portion comprising a cavity therein; and
a second filter portion filled with a filtration material.

10. The smoking article of claim 1, further comprising:
a segment wrapper comprising:
the medium accommodation portion wrapper; and
at least one of a moisturizer accommodation portion wrapper, a first filter portion wrapper, and a second filter portion wrapper,
wherein a plurality of segments comprising the medium accommodation portion, the moisturizer accommodation portion, and filter portion are wrapped with the segment wrapper and the segment wrapper is wrapped with a total wrapper.

11. An aerosol generating device, wherein the aerosol generating device is configured to receive the smoking article of claim 1 and provide an aerosol inhalable by a user by heating an aerosol generating material stored in the smoking article.

12. The aerosol generating device of claim 11, comprising:
an elongated cavity configured to accommodate the smoking article;
a heater configured to heat the medium accommodation portion and the moisturizer accommodation portion of the smoking article; and
a controller electrically connected to the heater.

13. An aerosol generating system comprising:
the smoking article of claim 1; and
an aerosol generating device configured to receive the smoking article of claim 1 and provide an aerosol inhalable by a user by heating an aerosol generating material stored in the smoking article.

14. The aerosol generating system of claim 13, wherein
the aerosol generating device comprises a heater configured to heat the medium accommodation portion and the moisturizer accommodation portion of the smoking article, and
a temperature of an unheated part of the smoking article ranges from 160° C. to 200° C.
